(19) United States
(12) Patent Application Publication
(10) Pub. No.: US 2026/0235744 A1
(43) Pub. Date: Aug. 13, 2026

(54) Miniature Hardware and Methods to Transmit and Receive Signals without Interference

(71) Applicant: Imperial College Innovations Limited, London (GB)

(72) Inventors: Frederic Bert Cegla, London (GB); Connor Joe Challinor, London (GB)

(21) Appl. No.: 19/469,717

(22) PCT Filed: Mar. 28, 2024
(86) PCT No.: PCT/EP2024/058704

§ 371 Date: Sep. 26, 2025

(30) Foreign Application Priority Data
Mar. 31, 2023 (GB) 2304842.4

(51) Int. Cl. G01S 7/524; G01S 7/527; G01S 15/86

(52) U.S. Cl. CPC G01S 7/524; G01S 7/5273; G01S 15/86

(57) ABSTRACT

An ultrasound device includes an ultrasound transducer having a terminal, a driver in electrical communication with the ultrasound transducer via the terminal, and a receiver in electrical communication with the ultrasound transducer via the terminal. The ultrasound transducer is configured to simultaneously transmit and receive a modulated signal.

### TECHNICAL FIELD

This disclosure relates to the field of ultrasound signal transmission and reception. More specifically, this disclosure relates to devices and methods in pulse-echo and pitch-catch (through transmission) measurements of Ultrasound signals. Ultrasound measurements may be used in medical diagnostic methods, for example scanning and measuring structures within the human or animal body. Ultrasound measurements may also be used in non-destructive evaluation processes, such as those for finding defects in materials and structures, or for determining sub-surface structure and material properties. The methods and devices may apply to Radio Frequency signals (RF signals) which are any signals in the frequency range of around 20 kHz to around 300 GHz.

Due to phenomena such as beam spread, attenuation and imperfect reflections and scattering, the recorded signals are weaker than the transmitted signals in ultrasound non-destructive evaluation. To overcome this and allow the signal to be digitized with sufficient Signal-to-Noise Ratio (SNR) and dynamic range, conventional systems employ temporally short high voltage pulsers and transmit receive switches that isolate the transmitter from the receiver and avoid overloading and saturating the receive amplifiers. The use of high voltage transmission signals results in higher amplitude received pulses and thus increases SNR against random noise. Because of the isolation of transmission and reception events, a conventional acquisition system cannot send and receive signals at the same time. This means that a short and sharp high amplitude signal is sent to the transducer or radiating element and after transmission the transducer is connected to an amplifier to increase the weaker received signals before they are digitized and recorded. Short pulses are used such that the reception stage can start quickly which reduces the dead-zone in received signals as well as to minimize the temporal width of received signals, this being important in improving the range resolution of the measurement. When short pulses are emitted in a multi-element transducer, at the receiver it is impossible to discern which transducer emitted a particular pulse. Therefore, for a comprehensive collection of data, one needs to fire on each transducer sequentially to collect a full set of data (full matrix capture) that has sent and received signals on all transducers.

The separation between the transmit and receive events has resulted in a particular hardware design for pulsed RF transmitters and receivers. In particular, in ultrasound specific electronics, hardware is required to produce the high voltage spikes, isolate them from the receive amplifiers, amplify the received signals and digitize the received signals. This hardware requires space, consumes energy and is expensive and in some applications, the supply of energy is limited and the availability of space is restricted, such as the use of miniaturized robots for inspection tasks or permanently installed sensors.

### SUMMARY

This disclosure relates to ultrasound devices and methods of operating the same as substantially described herein. This disclosure is defined by the appended claims as will be understood in light of the following description and figures.

### BRIEF DESCRIPTION OF THE DRAWINGS

FIG. 1 shows a schematic of a conventional RF/ultrasound pulse echo system including switching circuits.

FIG. 2 shows a schematic of an RF/ultrasound pulse echo system according to an embodiment of the present invention.

FIG. 3a shows a conventional aperiodic sequence and corresponding auto-correlation result.

FIG. 3b shows a conventional random long sequence and corresponding auto-correlation result.

FIG. 4 shows an exemplary long sequence, its auto-correlation and a corresponding correlation result against an appropriate modified template which produces a correlation peak and exclusion zone according to an embodiment.

FIG. 5 shows the correlation result of an exemplary long sequence against a fixed appropriate template as the exemplary long sequence is circularly shifted.

FIG. 6a shows first and second members from a family of circularly shifted long sequences and corresponding correlation results within the exclusion zone as all of the family members are filtered against the respective templates from the first and second sequences.

FIG. 6b shows third and fourth members of the family of circularly shifted long sequences of FIG. 6a and corresponding correlation results within the exclusion zone as all of the family members are filtered against the respective templates from the third and fourth sequences.

### DETAILED DESCRIPTION

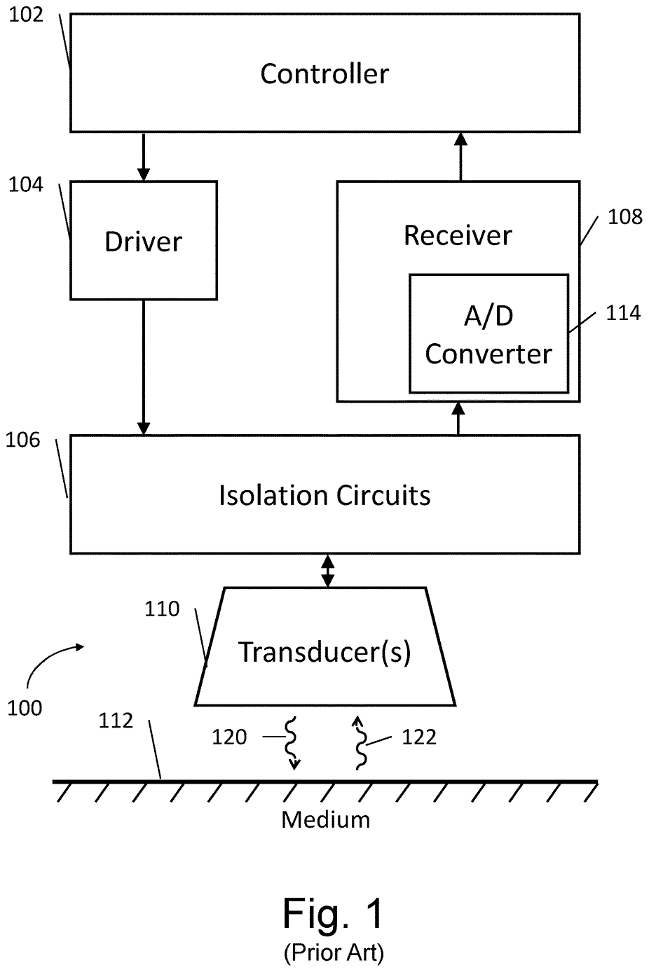

With respect to FIG. 1, is a schematic of a conventional ultrasound system (e.g., a conventional system 100). A conventional ultrasound system (e.g., a conventional system 100) may include a controller 102 for controlling the conventional system 100. The controller 102 may also provide some analysis of the signals obtained from the rest of the conventional system 100, or it may provide communication to another computer or processor for analyzing those signals. The controller 102 controls a driver 104 which provides the electrical power to drive the transducer 110 to emit ultrasound energy 120 into a medium 112. The electrical power provided by the driver 104 to the transducer 110 may be at a high voltage to ensure a clear return response with a good signal to noise ratio. When the ultrasound energy 120 is emitted into the medium 112, the structure of the medium 112 and its physical properties may determine a reflected or returned response 122. For example, changes in density or wave speed within the medium may cause reflection of the ultrasound energy 120, or a portion thereof, which results in the return response 122. The transducer 110 is capable of converting electrical energy into an ultrasound signal, but also of converting a return ultrasound response 122 into electrical energy. The electrical signal generated by the transducer 110 in response to the returned response 122 is passed to a receiver 108. The receiver 108 includes an analog to digital (A/D) converter 114 which provides a digital signal corresponding to the electrical signal provided from the transducer 110 to the receiver 108. In turn, the digital signal is provided back to the controller 102 so that the returned response 122 can be processed for analysis of the medium 112. Importantly, in the conventional ultrasound system (e.g., a conventional system 100) depicted in FIG. 1, the driver 104 and the receiver 108 are in communication with the transducer 110 via one or more switching circuits 106. In a conventional system 100, the switching circuits 106 are important because it is desirable to drive the transducer 110 with a high amount of power to maximize the ultrasound energy 120 emitted into the medium 112, but it is also able to record the returned response 122 at the receiver 108 over a reduced voltage range and with sufficiently high precision, such that the signal is prominently detectable above the noise floor determined by the dynamic range of the A/D converter 114.

Since conventional systems 100 require isolation of the driving circuits and the measuring circuits by means of switching circuits 106 or non-linear isolation circuits in order to function properly and detect signals, there is an additional cost, complexity, and size to the conventional systems 100 which could be mitigated if those switching circuits 106 could be simplified or removed entirely. The cost and complexity of switching circuits 106 or non-linear isolation circuits in Radio Frequency measurement is high due to the requirement that high voltages must be switched or isolated as fast as possible. In addition, the very presence of the switching circuits 106 means that a single transducer 110 cannot be used to simultaneously emit ultrasound energy 120 and measure a returned response 122. Rather, at any one time, the transducer 110 may be used either to emit energy 120 or measure the response 122. In practice, switching circuits 106 will not be perfect which results in some of the emitted energy 120 being distorted and spilling over into response 122 resulting in some dead time, a period when the received signal is usually discarded because it is compromised by the breakthrough from the emitted energy.

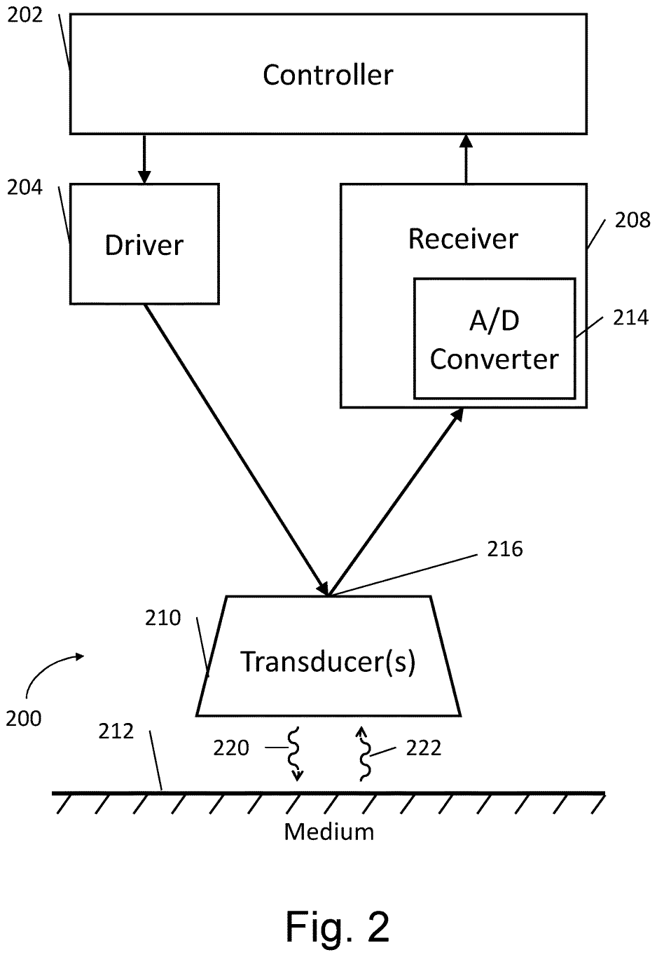

Now, with reference to FIG. 2, an exemplary ultrasound system (e.g., ultrasound system 200) according to an embodiment of the present invention is described. FIG. 2 shows a schematic of an ultrasound system 200 according to an embodiment. The ultrasound system 200 may include a controller 202 for controlling the system 200. The controller 202 may also provide some analysis of the signals obtained from the rest of the system 200, or it may provide communication to another computer or processor for analyzing those signals. The controller 202 controls a driver 204 which provides the electrical power to drive the transducer 210 to emit ultrasound energy (e.g., the transmitted modulated signal 220) into a medium 212. The electrical power provided by the driver 204 to the transducer 210 may be at a relatively low voltage compared to a conventional ultrasound system, or alternatively the electrical power provided by the driver 204 to the transducer 210 may be at a conventional or high voltage. When the ultrasound energy (e.g., transmitted modulated signal 220) is emitted into the medium 212, the structure of the medium 212 and its physical properties may determine a reflected or returned response (e.g., return signal 222). For example, changes in density or wave speed within the medium may cause reflection of the ultrasound energy (e.g., transmitted modulated signal 220), or a portion thereof, which results in the return response (e.g., return signal 222). The transducer 210 is capable of converting electrical energy into an ultrasound signal, but also of converting a return ultrasound response (e.g., return signal 222) into electrical energy. The electrical signal generated by the transducer 210 in response to the returned response (e.g., return signal 222) is passed to a receiver 208. The receiver 208 includes an A/D converter 114 which provides a digital signal corresponding to the electrical signal provided from the transducer 210 to the receiver 208. In turn, the digital signal is provided back to the controller 202 so that the returned response (e.g., return signal 222) can be processed for analysis of the medium 212.

The ultrasound driver 204 and the receiver 208 are in direct communication with the transducer 210 simultaneously. That is, the receiver 208 is constantly recording the signal at the terminals of the transducer 210 without switching or interruption. The receiver 208 is configured to simultaneously measure the driving signal from the driver 204 and the converted return response (e.g., return signal 222) from the medium. The A/D converter 214 of the receiver 208 is configured to have a range over which it can record a voltage at the terminals of the transducer 210. The range of the A/D converter 214 may be chosen to exceed the maximum range of voltages which may be applied by the driver 204. The range of the driver 204 may be either limited by its physical nature (i.e., the driver 204 is not physically capable of providing a greater driving signal) or it may be limited by software or capping of the maximum driving signal to be supplied. Since the maximum range of the A/D converter 214 exceeds the driving voltage of the driver 204, the A/D converter may provide a full, unclipped measurement of the driving signal. Since the returned response (e.g., return signal 222) is invariably less than the driven signal provided by the driver 204, such a range also ensures that the full return response (e.g., return signal 222) may be measured without clipping.

Since there is no switching circuit provided in the embodiment shown in FIG. 2, the size, energy requirements, complexity, and cost of the system 200 can be significantly reduced. However, steps may be taken to reduce the impact that such changes might have on the recovered signal to noise ratio of the measured response of the transducer 210.

One step that can be taken to increase the recovered signal to noise ratio is to increase the total transmitted energy of the ultrasound energy (e.g., transmitted modulated signal 220) emitted into the medium 212. The total transmitted energy may be increased by transmitting a temporally long coded signal based on a pre-defined sequence which contains a relatively high amount of energy at a lower voltage. This works because the signal to noise ratio may be proportional to the total transmitted energy. The coded signal received by the transducer 210 may be match filtered (e.g., to remove noise from outside of the expected frequency of the response signal) and/or pulse compressed to retrieve a short time domain signal that has a relatively high signal to noise ratio. The receiver 208 may also isolate the driven signal from the driver 204, since this is known from the controller 202 controlling the driver 204.

It is well accepted in the field of ultrasound measurement that sequences with favorable aperiodic correlation properties are suited for pulse-echo applications. Periodic sequences are expected to be of use in through transmission or other continuous wave applications since periodic sequences having favorable properties exist only in lengths that require the excitation duration to exceed the time duration in which useful information is expected to arrive in pulse-echo applications meaning the traditional hardware architecture (e.g., the conventional system 100) is unsuitable due to the need to simultaneously transmit and receive. The use of periodic sequences in an aperiodic manner may be applicable for pulse-echo applications but not in conjunction with the traditional hardware architecture (e.g., the conventional system 100) since the limitation on excitation duration imposed by the hardware architecture (e.g., the conventional system 100) significantly reduces the length of sequence that can be used. The use of short excitation durations with periodic sequences results in filtered signals containing significant filter artefacts making further analysis complex or impossible.

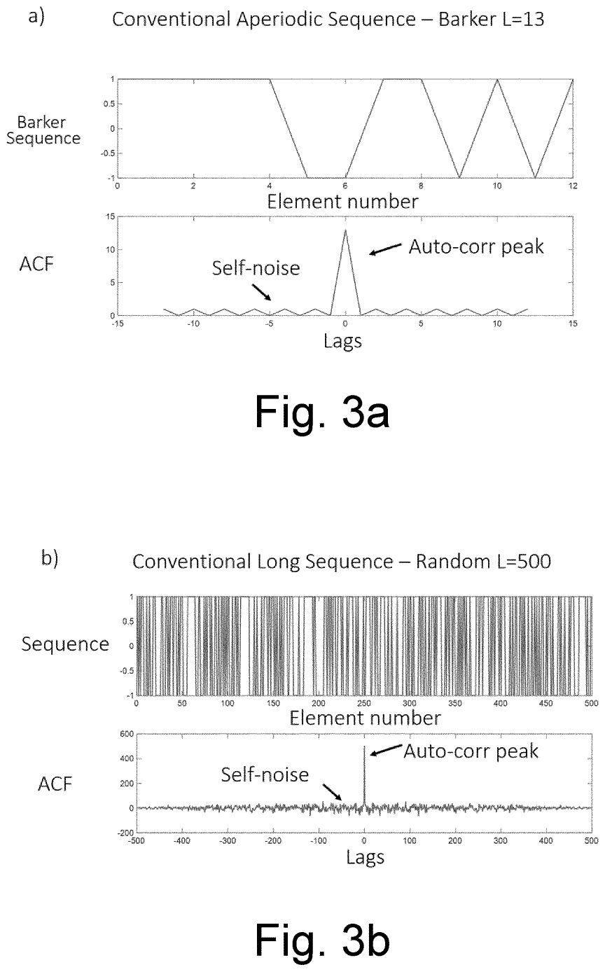

FIG. 3a shows a conventional aperiodic sequence which may be encoded into an ultrasound signal emitted from an ultrasound system. The sequence shown in FIG. 3a is a binary Barker Sequence of length 13 taking the values [1,1,1,1,1,−1,−1,1,1,−1,1,−1,1]. The first chart of FIG. 3a shows the Barker sequence. The second chart in FIG. 3a shows the result of an autocorrelation of the Barker Sequence. The autocorrelation function of the Barker Sequence shows a strong auto-correlation peak at zero time lag (indicating a strong confidence of correlation of the signal) surrounded by a low level of self-noise. Self-noise is essentially an indication that there is some degree of correlation between a signal and itself when it has been time shifted and may lead to be falsely identified as being due to the presence of another signal. The Barker Sequence is often described as having one of the best autocorrelation properties because of the strong auto-correlation peak and surrounding low level of self-noise.

FIG. 3b shows another conventional aperiodic random sequence with a length of 500. A random sequence of long enough length will result in a good auto-correlation response because the chance of correlation noise from separate sections with the sequence diminishes as the sequence length increases. The first chart in FIG. 3b shows an exemplary random sequence in a binary [1,−1] signal and the second chart in FIG. 3b shows the auto-correlation of that sequence. As can be seen, a long enough random sequence results in a strong auto-correlation peak surrounded by self-noise created by a degree of similarity between the random sequence time lagged.

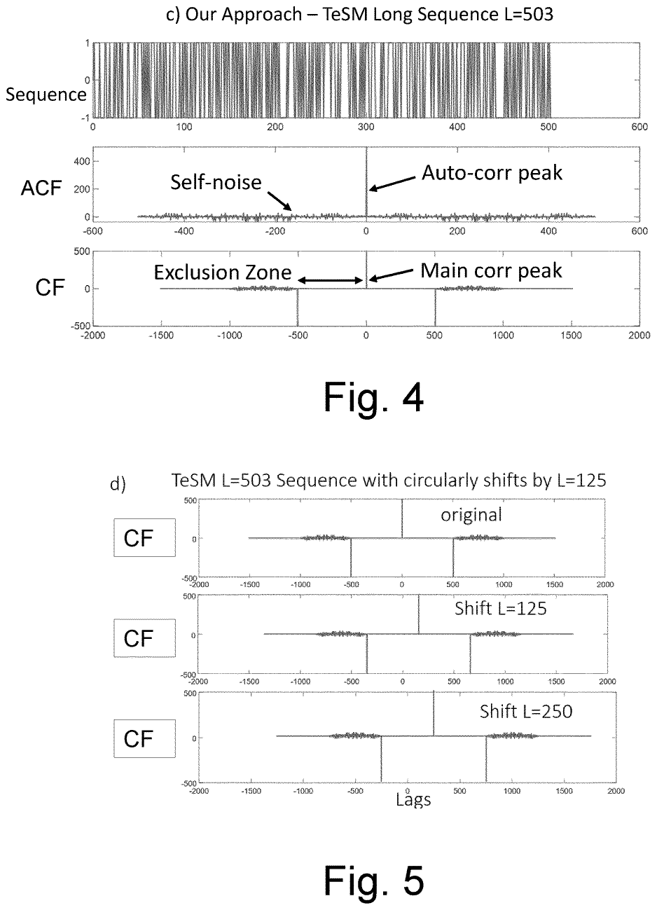

FIG. 4 shows an exemplary long sequence according to an embodiment of the present invention. The first chart in FIG. 4 shows the ternary [1,0,−1] coded sequence with a length of 503 elements. At a cursory glance, the sequence appears similar to a random sequence, but it differs in a number of respects. The sequence shown in FIG. 4 is configured to have a perfect correlation response within a specific zone if correlated against a signal that consists of multiple concatenated copies (N=3 in the example of FIG. 4) of the original coded sequence which is known as the template. That is, the correlation result contains a main peak when the central section of the template aligns with the original coded sequence. At any number of elements up to the sequence length (e.g. 503 in FIG. 4) in either direction of the main peak, the correlation result is zero. The zero response is known as an exclusion zone. The use of a sequence which has a correlation output including an exclusion zone surrounding a correlation peak as exemplified by the sequence shown in FIG. 4 means that the returned response will not be surrounded by filter artefacts which can cause confusion to the analysis of the response. Additionally, reflections from nearby reflectors in the medium will not produce an overlap of filter artefacts that can significantly increase the amplitude of artefacts. Further, the sequence is long (for example, compared to the Barker sequence) which means that the total energy is high. Therefore the correlation of the returned response (e.g., return signal 222) may allow for low voltage or low power signals to be applied to a medium 212 over a period of time to produce an ultrasound response with an excellent signal to noise ratio.

A further benefit of the near-perfect correlation response of the sequence exemplified in FIG. 4 is that the dynamic range of the ultrasound system 200 may be improved. The level of the noise either side of the correlation peak in comparison to the peak itself sets the dynamic range of the system. Since the difference between the correlation peak and the exclusion zone is as much as is possible, the dynamic range of the system is theoretically infinite or perfect, and only limited by imperfections of the hardware implementation.

### Description of Hardware Implementation

In an embodiment of the invention, there is provided an ultrasound system 200 including an ultrasound transducer 210 having a terminal 216. The ultrasound device includes a driver 204 in electrical communication with the ultrasound transducer 210 via the terminal 216, and a receiver 208 in electrical communication with the ultrasound transducer 210 via the terminal 216. Since both the driver 204 and the receiver 208 are in constant electrical communication with the transducer 210 via the terminal 216, the receiver 208 is also in electrical communication with the driver 204 via the terminal 216. The ultrasound transducer 210 is configured to simultaneously transmit and receive a modulated signal 220, 222. While the transducer 210 is depicted as having a single terminal 216 for clarity, the transducer 210 may have one or several connectors which make up a complete electrical circuit, the terminal 216 including one or all of the connectors.

The receiver 208 is configured to continuously measure the terminal 216 of the ultrasound transducer 210 for the duration of the transmitted signal (e.g., transmitted modulated signal 220). For example, the receiver 208 may continuously record the voltage level at the terminal 216 while the signal (e.g., transmitted modulated signal 220) is being transmitted and when the return signal 222 is being received by the transducer 210 without interruption. In this way, the receiver 208 may record the entire return signal 222 without interruption. Conversely, previous systems may require interruption of the receiver recording a return signal to allow for the transmitted signal to be emitted.

The receiver 208 may be configured to continuously measure the terminal 216 of the ultrasound transducer 210 for an additional measurement period to make up a received signal. That is, the receiver 208 may continuously measure the return signal 222 as well as the output from the driver 204 at the terminal 216 of the transducer 210 for a time period after the whole signal has been transmitted. The additional time period may be up to 1000 times the length of the transmitted signal (e.g., transmitted modulated signal 220).

The transmitted modulated signal 220 may be modulated according to a pre-defined sequence. In order to modulate the transmitted modulated signal 220 according to the pre-defined sequence, the property of the transmitted modulated signal 220 which is modulated may be the phase of the signal, the frequency, or the amplitude or a mixture of these properties. The pre-defined sequence may be a binary sequence such that it takes the values of 1 and −1 (or 1, and 0, on and off, high and low, etc.), or a ternary sequence that takes the value of either 0, 1 or −1.

The modulated component of the transmitted signal (e.g., transmitted modulated signal 220) may be a pre-defined symbol or a waveform. As such, the pre-defined symbol may be matched in frequency content to the frequency response of the ultrasound transducer. By matching the frequency content of the pre-defined symbol to the frequency response of the ultrasound transducer 210, the pre-defined sequence may be effectively used on a specific ultrasound transducer and tuned to that ultrasound transducer 210. In this way, the pre-defined sequence may be used to modulate the phase, frequency, or amplitude of repeated copies of the pre-defined symbol. The length of the pre-defined symbol may be user configurable. By configuring the length of the pre-defined symbol, the bandwidth of the transmitted modulated signal 220 may be adjusted.

The transmitted modulated signal 220 is applied to the transducer terminal 216 a first time. In this way, the pre-defined sequence may be used aperiodically. That is, the transmitted modulated signal 220 may be emitted from the transducer 210 a single time and the return signal 222 measured a single time. A further transmitted signal (e.g., transmitted modulated signal 220) may be emitted at a later point in time after the first time. However, the transmitted modulated signal 220 is not periodic (i.e., it does not repeat at a regular time interval).

The ultrasound system 200 further includes a processor (e.g., controller) 202 in communication with the receiver 208. The processor is configured to filter the received signal (e.g., return signal 222) using a matched filter to produce an output signal. The matched filter is constructed from a corresponding template signal. The corresponding template signal may be produced to correspond to the transmitted modulated signal 220 such that the filtered output signal provides information about the medium 212 through which the receiver signal 222 has passed.

The template signal can be produced by concatenating N copies of the transmitted modulated signal. That is, the template signal may be made up of a plurality of copies of the transmitted modulated signal concatenated together. N may be any integer greater than 1. During the concatenation of the N copies, the copies may be alternatingly multiplied by −1. The template signal can also be derived from the pre-defined sequence by concatenating N copies of a signal that is made up of a modulation of a symbol by the pre-defined sequence where the symbol is different to the pre-defined symbol that was used to produce the transmitted modulated signal.

In an alternative embodiment, the pre-defined sequence is constructed from two complementary Golay sequences. For example, the two complementary sequences may be chosen which if combined will have perfect correlation properties. That is, the complementary sequences will contain self-noise in their respective autocorrelations that is alike in position but opposite in polarity, thus allowing the perfect cancellation of self-noise by summing the two autocorrelations while also doubling the amplitude of the correlation peak. Each of the complementary Golay sequences may be separated by a fixed offset amount. The fixed offset amount may be fixed such that the offset between the complementary sequences is known. In between the complementary sequences, the values of the pre-defined sequence are zero, that is, during the offset between the complementary sequences there is a zero signal. The time difference (DTG) between the start of the first Golay sequence of the two complementary Golay sequences and the start of the second Golay sequence of the two complementary Golay sequences may be user-definable.

To produce an output signal from the returned signal (e.g., return signal 222), the matched filter result may be shifted by the DTG to produce a shifted matched filter result. Combining the matched filter result with the shifted matched filter result by adding the matched filter result to the shifted matched filter result produces an output signal. If, for example, the pair of Golay sequences have been received and are separated by the DTG in the matched filter result, then the sum (e.g., a summation) of the matched filter result and the shifted matched filter result will indicate strong correlation without self-noise.

In an alternative embodiment, the pre-defined sequence is configured to have a correlation function against N concatenated copies of itself having a main correlation peak surrounded by an exclusion zone of the length L_{seq} of the pre-defined sequence either side of the correlation peak which itself is surrounded by additional correlation peaks and regions containing self-noise. That is, the pre-defined sequence may be constructed or chosen that has ideal or perfect correlation properties within a specific window when correlated against an appropriate template. The exclusion zone of the correlation function output is zero for L_{seq} shifts either side of the central correlation peak, where L_{seq} is the length of the pre-defined sequence. The N concatenated copies of the correlation function may be alternatingly multiplied by −1. That is, every other concatenated copy of the pre-defined sequence may be inverted.

To produce the output signal, the processor (e.g., controller 202) may select a region in the filter output starting at J times the length of the transmitted modulated signal 220 and ending at J+1 times the length of the transmitted modulated signal. For example, if J is equal to 1000, J+1 would be equal to 1001. For example, a region in the filtered output between two times the length of the transmitted modulated signal 220 and three times the length of the transmitted modulated signal 220 may be chosen. N is a positive integer greater than 1. J may be less than N, such that the selected region is within the received modulated signal (e.g., return signal 222) corresponding to the transmitted modulated signal 220.

The ultrasound system 200 described herein may be implemented across a plurality of ultrasound transducers 210. Each of the plurality of the ultrasound transducers 210 may be configured to simultaneously transmit and receive a modulated signal, and be operated simultaneously. The modulation of signals described herein allows the simultaneous transmission and reception across the plurality of ultrasound transducers 210 while allowing for isolation of the individual signals corresponding to each of the plurality of transducers 210.

Each of the plurality of ultrasound transducers 210 may be configured to transmit a different modulated signal, and each different modulated signal includes a different pre-defined sequence in a family of pre-defined sequences. The family of pre-defined sequences may be chosen as described below.

Each different pre-defined sequence in the family of pre-defined sequences has a correlation function against N concatenated copies of itself having a correlation peak and a correlation exclusion zone. That is, each point up to the length of the pre-defined sequence in the correlation exclusion zone is zero except for the central correlation peak. Additionally, each pre-defined sequence in the family of pre-defined sequences has a correlation function against N concatenated copies of every other pre-defined sequence in the family of pre-defined sequences having a cross-correlation exclusion zone in the same region as the correlation exclusion zone, wherein each point in the cross-correlation exclusion zone is zero. That is, when a single sequence of the family of pre-defined sequences is correlated with its own template, it produces a strong correlation peak surrounded by a zero region. However, when any member of the family of sequences is cross-correlated with the template of another member of the same family of sequences, there is no correlation peak and there is a zero region in the same exclusion zone. The N concatenated copies of the correlation function may be alternatingly multiplied by −1, that is, every other one of the N concatenated copies may be inverted.

Each pre-defined sequence in the family of pre-defined sequences may be a circularly shifted copy of the same pre-defined sequence. The same pre-defined sequence may be used in this way where it is chosen or generated to have the correlation properties described herein. Since there is an exclusion zone surrounding the correlation peak, by circularly shifting a copy of the same pre-defined sequence to produce an additional pre-defined sequence in the family of pre-defined sequences, two pre-defined sequences in the same family will produce an indication of zero correlation within the exclusion zone when cross-correlated against each other's template. Each pre-defined sequence in the family of pre-defined sequences may be an, odd-periodically-circularly shifted copy of the same pre-defined sequence. That is, each circularly shifted element may be inverted during the shifting process.

The shift amount by which to circularly shift the first sequence to produce a new sequence may be determined by the index of the sequence within the family of the pre-defined sequences and M elements, where M may be any integer larger than 1 and M controls the duration of the exclusion zone in the filtered signals. For example, where the first sequence has a length of 500 elements, the sequence may be shifted between 1 and 500 times before the sequence is repeated. The maximum size of the family may therefore be determined by the length of the sequence relative to the size of M. For the example where M=100 and L_{seq}=500, a maximum family size is 5 results. Since the number of sequences available within a family is determined by the length of the first sequence, the length of the first pre-defined sequence may be configured to be the product of the number of transducers and M. In this way, the length of the sequence and the size of the family of sequences may be configured to correspond to the number of transducers which may be operated simultaneously without interference. Each sequence may then be produced by shifting the first sequence by the product of M with the index of the sequence within the family.

Each pre-defined sequence in the family of pre-defined sequences may be produced using odd-periodic multiplication of a primer sequence against a modified extended Hadamard matrix. The primer sequence may be defined as M elements, where M is an integer larger than 1, and the size of the extended Hadamard matrix may be chosen to produce a family of pre-defined sequences greater than the number of transducers used by the ultrasound device. In this way, the length of the sequence and the size of the family of sequences may be configured to correspond to the number of transducers which may be operated simultaneously without interference.

By using unique sequences for each of the plurality of transducers, a full matrix of ultrasound signal data can be recorded simultaneously. Each transmission signal is applied to each transducer with the received signal for each transducer then recorded which contains its own driven signal and all the returned ultrasound energy incident on the transducer. Each transmission signal is made into a template by concatenating the transmission signal N times. The pulse-echo signal for each transducer may then be recovered by matched filtering the received signal from that transducer with its own template and extracting the region of J to J+1 times the transmission signal length from the correlation result, thus producing F pulse-echo signals for F transducers. Each transducer's received signal may then be filtered against the template for each other of the plurality of transducers and extracting the region of J to J+1 times the transmission signal length from the correlation result to recover the through transmission ultrasound energy that may have propagated between each transducer pairing, thus producing F²-F pitch-catch signals.

The ultrasound device may include an analog to digital (A/D) converter 214 configured to provide a digital output signal corresponding to a voltage measurement at the terminal 216. In this way, the processor (e.g., controller 202) may interpret the received signal (e.g., return signal 222) in a digital form. The A/D converter 214 is configured to have a measurable voltage range larger than the peak voltage output of the electrical driver 204. In this way, the receiver 208 may measure the full transmitted signal (e.g., transmitted modulated signal 220), and therefore also the full received signal (e.g., return signal 222) without clipping.

### Method of Implementation

In an implementation of the present invention, there is provided a method of transmitting and receiving RF signals in a medium including driving a transceiver element configured to apply a Radio Frequency (RF) signal to the medium, and, simultaneously to the driving of the transceiver element, measuring the response of the transceiver element to the RF signal received from the medium. It will be appreciated that radio frequency is frequency in the range of 20 kHz to around 300 GHz. While the present disclosure presents systems and methods with hardware specific to ultrasound, the same systems and methods may be applied to other radiation, for example electromagnetic radiation. In the embodiments described herein, ultrasound is considered to cover sound waves operating at frequencies in the range of 20 kHz up to several 100 Megahertz.

The steps of driving and simultaneous measuring of the response may be performed without switching between driving the transceiver element and measuring the response of the transceiver element. As explained herein, by avoiding the switching between driving the transceiver element or transducer and measuring the response of the transceiver element or transducer, the expense, size, power, and complexity of the switching circuitry and high voltage hardware may be avoided. The steps of driving and simultaneous measuring of the response may be performed without isolation or separation of the driver and the receiver. For example, non-linear isolation circuits would not be required. The driver and the receiver may be in continuous electrical communication.

Measuring the response of the transceiver element may include converting the analog signal from the transceiver element to a digital signal representative of that analog signal. Conversion of the analog signal to a digital signal allows processing of the signal and recovery of the encoded information in that signal to be performed. The digital signal is chosen to have a range which covers at least the full range of the driving signal applied by the driver. This allows the full range of measurements applied to and received from the transducer to be captured without clipping.

The RF or ultrasound signal may be modulated according to a pre-defined sequence. The pre-defined sequence is therefore encoded into the ultrasound or RF signal and may be recovered from that signal by demodulating the signal. The pre-defined sequence may be modulated by any conventional means of modulation, but specifically these may include one or more of phase modulation, frequency modulation and/or amplitude modulation.

As explained with reference to FIG. 4, the pre-defined sequence may be configured to have a correlation function against a template signal having a correlation peak and an exclusion zone of the same length as the pre-defined sequence (e.g. a perfect correlation response within a predefined window, 503 in the example of FIG. 4). More specifically, wherein in the exclusion zone, the correlation of the pre-defined sequence against the template is zero. While there are many possible sequences which may be generated to fulfill the conditions of providing a perfect correlation response, one method of generating a suitable pre-defined sequence will now be described in detail. It is important that the pre-defined sequence provides the response as defined herein, however, it is not essential that the exemplary method is used to generate such a sequence.

### Producing Exemplary Sequences

The following is a description of one example of how appropriate sequences may be generated in accordance with the present invention. However, it will be appreciated that other methods of sequence generation may be used to produce similar sequences which achieve the same effects as the exemplary sequences described herein.

The sequences provided in this example are ternary sequences. In contrast to a binary signal that can only take two values, e.g., 1 and 0 or +1 and −1, a ternary signal is a signal that can take three values, in the examples given herein this is +1, 0 and −1. The coded ternary signals can be made up of two components. The first component is the control sequence (seq). The second component is the symbol (sym). Both the control sequence and the symbol may be arrays of ternary values that have L number of elements (i.e., L_{seq} and L_{sym}).

For every control sequence element, the symbol is repeated where the control sequence value controls a property of the symbol. The property of the symbol relates to the modulation of the sequence and could be frequency or phase or amplitude or a mixture of these. In this exemplary case it is the phase and amplitude of the symbol. Therefore, for a control sequence value of +1 all symbol values are multiplied by +1, for a value of −1 they are multiplied by −1 and for a value of 0 they are set to zero.

The data rate and symbol may be matched to the bandwidth of the transducer to achieve the highest transmission efficiency. Matching the symbol is achieved by setting the frequency of the switching within the symbol to match the frequency at which the transducer responds most effectively. That is, the transmission signal may be made up of modulated copies of symbols such that it matches the operating frequency of the transducer.

The length and the particular order in which the values of the control sequence vary determines the output characteristics after correlation. Any type of control sequence, even randomly generated ones, will have an auto-correlation response that includes a large main lobe or auto correlation peak at the zero shift/time lag value and side lobes (or noise, or self-noise) at other time lags. It is desirable to achieve a large main lobe with minimal or no side lobes. In one embodiment, control sequences that have a large main lobe and no side lobes (i.e., theoretically perfect compression performance) within a certain number of samples of the main lobe are used. The zone of zero values between the main and the side lobes is called the exclusion zone and the number of samples of the exclusion zone can be defined as the Lez.

The sequence may be generated using primitive polynomial element generation according to the following equation:

$$s ( n ) = χ \{ {[ \frac{{ϵ}^{q n} - {ϵ}^{n}}{{ϵ}^{q} - ϵ} ]}^{\frac{q - 1}{2}} \} \qquad [ Equation \#1 ]$$

In Equation 1, s is the sequence, n is the element number of the sequence s, q is an odd prime number, ϵ is the primitive element of the extension field GF(q²) created from a second order primitive polynomial over q, and x is the Legendre symbol (outputs 0 for an input 0, outputs 1 for an input 1, outputs −1 for any other input). The element number n exists over a range from 0 to q.

### Control Sequence Families

The exemplary control sequences can be made into families such that every member when correlated with its corresponding template (i.e., N concatenations of itself in the preferred embodiment description related to FIG. 4) results in a main lobe of the same amplitude and an exclusion zone of the same length. Whereas if the control sequence is cross correlated against the template of another family member, the response will be zero at the location of the main lobe and throughout the whole exclusion zone. By ensuring the sequence length is of sufficient length for a given exclusion zone for a set family size of F members and of sufficient length for a required SNR gain, the system is ensured to produce high quality signals for the measured window of interest which also have complete removal of crosstalk/interference between measurement channels.

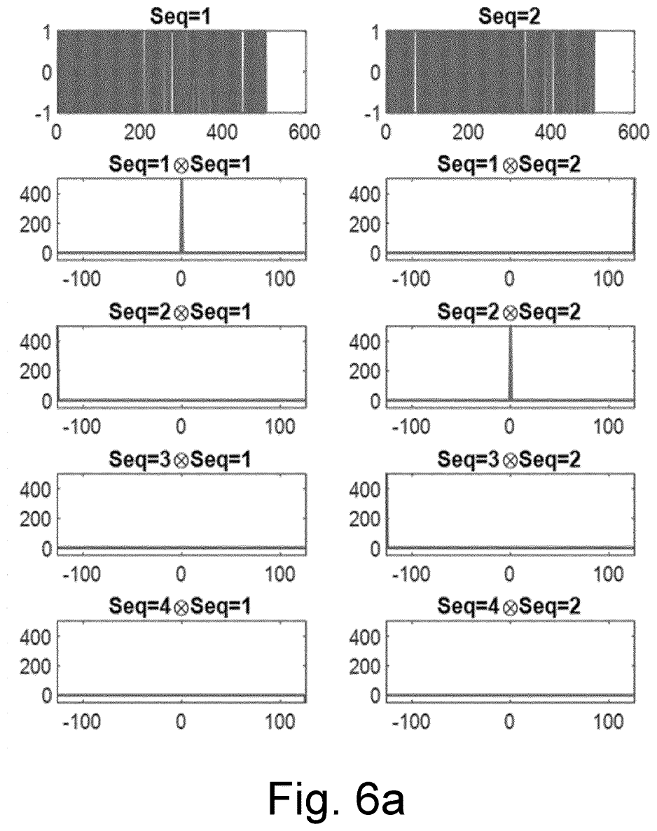

With respect to FIG. 5, three correlation outputs of sequences correlated against a fixed template are shown, the sequences that have been created by circularly shifting the sequence of the first member of the family by a number of and the template that is produced by concatenating the first sequence three times. In the cases shown in FIG. 5, the two additional family members have been created by odd-periodically circularly shifting the original sequence by 125 and 250 elements respectively. Circular shifting of the original sequence to produce multiple family members is possible, in part, due to the perfect correlation response in the exclusion zone of the sequence when correlated against an appropriate template. For example, since the correlation response of the original sequence time shifted, or lagged by 125 sequence elements is zero, circularly shifting the sequence elements by 125 results in a pre-defined code containing the same elements in different locations which do not interfere with signals of the original sequence. In this way, if the original sequence includes 503 elements, at least 503 separate family members of the sequence may be provided through circular shifting of the original sequence. Circular shifting of the sequence may be achieved by assigning each sequence element to a new position. For example, the first element may be shifted to the position of the second, the second to the third and so on. The last element of the sequence may be circled back to the position of the first element. For odd-periodic circular shifting, the last element may be inverted (i.e. multiplied by −1) before being circled back to the position of the first element. In this way, multiple family members of sequences related to an original sequence may be provided.

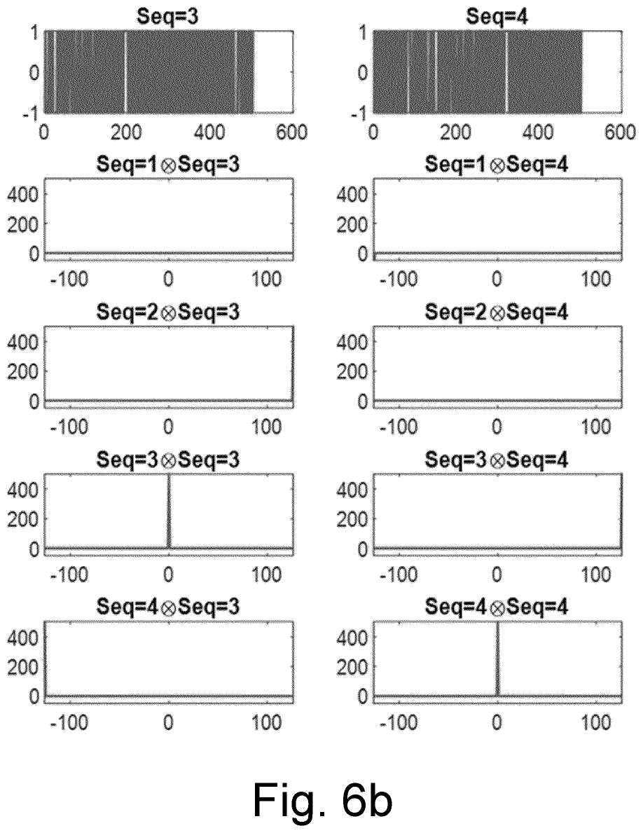

With reference to FIGS. 6a and 6b, a benefit of the creation of multiple family members of pre-defined sequences according to the present disclosure will be appreciated. FIG. 6a shows a first sequence and a second sequence in a family of circularly shifted pre-defined sequences. Sequence 1 is shown to have a perfect correlation response while providing a zero response to cross correlation with any of the sequences 2, 3 or 4. Sequence 2 is an odd-periodically-circularly shifted sequence belonging to the same family as sequence 1. Sequence 2, similarly, provides a zero response to cross correlation with any of sequences 1, 3 or 4, and a perfect correlation with its own template. Turning to FIG. 6b, sequences 3 and 4 provide the same perfect autocorrelation response, while providing a zero response to cross correlation with any of the other sequences. This perfect correlation response in combination with no interference between members of the same family means that many pre-defined sequences may be generated from a single original pre-defined sequence without requiring the further generation of original sequences. Furthermore, members of pre-defined sequences from different families may have a non-zero chance of causing interference when cross-correlated.

By providing circularly shifted pre-defined sequences as described herein, multiple different family members may be used for multiple sensors in an array. Since the pre-defined sequences in the same family do not cause cross correlation interference with one another, the array of transducers may be used simultaneously while extracting the full dynamic range available and the greatest possible signal to noise ratio for the hardware.

The following is a non-exhaustive list of aspects of the present disclosure Aspect A1.

An ultrasound device including ultrasound transducer having a terminal, a driver in electrical communication with the ultrasound transducer via the terminal, and a receiver in electrical communication with the ultrasound transducer via the terminal, wherein the receiver is in electrical communication with the driver via the terminal, and wherein the ultrasound transducer is configured to simultaneously transmit and receive a modulated signal.
Optionally, the transmitted signal of Aspect A1 is generated by the controller/driver and the received signal corresponds to the ultrasonic response of the medium under test.
Aspect A2. The ultrasound device of Aspect A1, wherein the receiver is configured to continuously measure the terminal of the ultrasound transducer for the duration of the transmitted signal.
Aspect A3. The ultrasound device of Aspect A2, wherein the receiver is configured to continuously measure the terminal of the ultrasound transducer for an additional measurement period to make up a received signal, optionally wherein the additional period is in the range of 0.1 to 1000 times the length of the transmitted signal.
Aspect A4. The ultrasound device of any preceding Aspect, wherein the transmitted modulated signal is modulated according to a pre-defined sequence and wherein the transmitted modulated property is one of phase, frequency, or amplitude.
Aspect A5. The ultrasound device of Aspect A4, where the pre-defined sequence is a binary sequence that takes the values of 1 and −1, or a ternary sequence that takes the value of either 0, 1 or −1.
Aspect A6. The ultrasound device of any of the preceding Aspects, wherein the modulated component of the transmitted signal is a pre-defined symbol, the pre-defined symbol being matched in frequency content to the frequency response of the ultrasound transducer, such that the pre-defined sequence is used to modulate the phase, frequency, or amplitude of repeated copies of the pre-defined symbol; and optionally wherein the length of the pre-defined symbol is configurable to adjust the bandwidth of the transmitted modulated signal, and further optionally wherein the length of the pre-defined symbol is user configurable to adjust the bandwidth of the transmitted modulated signal.
Aspect A7. The ultrasound device of any preceding Aspect, wherein the transmitted modulated signal is applied to the transducer terminal a first time such that the pre-defined sequence is used aperiodically.
Aspect A8. The ultrasound device of any preceding Aspect, further including a processor in communication with the receiver, wherein the processor is configured to filter the received signal using a matched filter constructed from a corresponding template signal to produce an output signal.
Aspect A9. The ultrasound device of Aspect A8, wherein the template signal is produced by concatenating N copies of the transmitted modulated signal.
Aspect A10. The ultrasound device of any of Aspects A4 to A9, wherein the pre-defined sequence is constructed from two complementary Golay sequences, each of the complementary Golay sequences being separated by a fixed offset amount, and optionally wherein the values of the pre-defined sequence within the fixed offset amount are zero, and further optionally wherein the time difference (DTG) between the start of the first Golay sequence of the two complementary Golay sequences and the start of the second Golay sequence of the two complementary Golay sequences is user-definable.
Aspect A11. The ultrasound device of Aspect A10, wherein an output signal is produced by shifting the matched filter result by the DTG to produce a shifted matched filter result, and adding the matched filter result to the shifted matched filter result to produce the output signal.
Aspect A12. The ultrasound device of Aspect A9, wherein the pre-defined sequence is configured to have a correlation function against N concatenated copies of itself having an autocorrelation peak surrounded by an exclusion zone, wherein the exclusion zone of the correlation function output is zero at all points other than the central autocorrelation peak; and optionally wherein the N concatenated copies of the correlation function are alternatingly multiplied by −1.
Aspect A13. The ultrasound device of Aspect A9, wherein the output signal is a selected region in the filter output starting at J times the length of the transmitted modulated signal and ending at J+1 times the length of the transmitted modulated signal, and optionally wherein N is a positive integer greater than 1 and J is less than N.
Aspect A14. The ultrasound device of any preceding Aspect, further including a plurality of ultrasound transducers, and wherein each of the plurality of the ultrasound transducers is configured to simultaneously transmit and receive a modulated signal, and optionally wherein the plurality of the ultrasound transducers are operated simultaneously.
Aspect A15. The ultrasound device of Aspect A14, wherein each of the plurality of ultrasound transducers is configured to transmit a different modulated signal, and wherein each different modulated signal includes a different pre-defined sequence in a family of pre-defined sequences.
Aspect A16. The ultrasound device of Aspect A15, wherein each different pre-defined sequence in the family of pre-defined sequences has a correlation function against N concatenated copies of itself having an autocorrelation peak and an autocorrelation exclusion zone, wherein each point in the autocorrelation exclusion zone is zero except for the central autocorrelation peak, and wherein each pre-defined sequence in the family of pre-defined sequences has a correlation function against N concatenated copies of each other pre-defined sequence in the family of pre-defined sequences having a cross-correlation exclusion zone in the same region as the autocorrelation exclusion zone, wherein each point in the cross-correlation exclusion zone is zero; and optionally wherein the N concatenated copies of the correlation function are alternatingly multiplied by −1.
Aspect A17. The ultrasound device of Aspect A16 when dependent on Aspect A12, wherein each pre-defined sequence in the family of pre-defined sequences is a circularly shifted copy of the same pre-defined sequence or is an odd-periodically-circularly shifted copy of the same pre-defined sequence, and optionally wherein the shift is determined by the index of the sequence within the family of the pre-defined sequences and M symbol widths, where M is an integer between 1 and 10000, and wherein the length of the first pre-defined sequence is configured to be the product of the number of transducers and M.
Aspect A18. The ultrasound device of Aspect A16 when dependent on Aspect A12, wherein each pre-defined sequence in the family of pre-defined sequences is produced using odd-periodic multiplication of a primer sequence against a modified extended Hadamard matrix, wherein the primer sequence is defined as M symbol widths, where M is an integer between 1 and 10000, and wherein a size of the extended Hadamard matrix is configured to produce a family of pre-defined sequences greater than the number of transducers used by the ultrasound device.
Aspect A19. The ultrasound device of any preceding Aspect, further including an analog to digital (A/D) converter configured to provide a digital output signal corresponding to a voltage measurement at the terminal; and optionally wherein the A/D converter is configured to have a measurable voltage range larger than the peak voltage output of the electrical driver.
Aspect A20. A method of transmitting and receiving ultrasound signals in a medium including driving an ultrasound transducer configured to apply a modulated ultrasound signal to the medium, and simultaneously to the driving of the ultrasound transducer, receiving the response of the medium under application of the modulated ultrasound signal.
Optionally, in the method of aspect A20 the RF transducer is configured to transmit an RF signal into a medium under test, with a modulated signal produced by a controller; and simultaneously to the driving of the RF transducer, the RF transducer is configured to receive a returned modulated RF signal corresponding to the response of the medium under test through the same RF transducer as used for the transmission event.
Aspect A21. The method of Aspect A20, wherein receiving the response of the medium is performed continuously through the reception of the entire modulated ultrasound signal from the medium.
Aspect A22. The method of Aspect A20 or Aspect A21, wherein the transmitted modulated signal is modulated according to a pre-defined sequence, and optionally wherein the transmitted modulated property is one of phase, frequency, or amplitude.
Aspect A23. The method of Aspect A22 further including defining the pre-defined sequence by primitive polynomial element generation of prime number Galois Field extensions to at least the power of two, and optionally, wherein the elements of the predefined sequence are defined according to the equation:

$$s ( n ) = {[ \frac{{ϵ}^{q n} - {ϵ}^{n}}{{ϵ}^{q} - ϵ} ]}^{\frac{q - 1}{2}} \qquad [ Equation \#2 ]$$

wherein s is the pre-defined sequence, n is the element of the pre-defined sequence, ϵ is the primitive element of the extension field GF(q2), and wherein n exists over the range 0-q.
Aspect A24. A method of transmitting and receiving ultrasound signals in a medium including providing an ultrasound device according to any of Aspect A1 to A19, driving the ultrasound transducer to apply a modulated ultrasound signal to the medium, and simultaneously to the driving of the ultrasound transducer, receiving the response of the medium under the application of the modulated ultrasound signal.
Aspect A25. The method of Aspect A20, further including continuously measuring the terminal of the ultrasound transducer for an additional measurement period to make up a received signal, optionally wherein the additional period is in the range of 0.1 to 1000 times the length of the transmitted signal.
Aspect A26. The method of any preceding Aspect, wherein the transmitted modulated signal is modulated according to a pre-defined sequence and wherein the transmitted modulated property is one of phase, frequency, or amplitude.
Aspect A27. The method of Aspect A26, where the pre-defined sequence is a binary sequence that takes the values of 1 and −1, or a ternary sequence that takes the value of either 0, 1 or −1.
Aspect A28. The method of any of the preceding Aspects, wherein the modulated component of the transmitted signal is a pre-defined symbol the pre-defined symbol being matched in frequency content to the frequency response of the ultrasound transducer, such that the pre-defined sequence is used to modulate the phase, frequency, or amplitude of repeated copies of the pre-defined symbol; and optionally wherein the length of the pre-defined symbol is user configurable to adjust the bandwidth of the transmitted modulated signal.
Aspect A29. The method of any preceding Aspect, wherein the transmitted modulated signal is applied to the transducer terminal a first time such that the pre-defined sequence is used aperiodically.
Aspect A30. The method of any preceding Aspect, further including filtering the received signal using a matched filter constructed from a corresponding template signal to produce an output signal.
Aspect A31. The method of Aspect A30, wherein the template signal is produced by concatenating N copies of the transmitted modulated signal.
Aspect A32. The method of any of Aspects A26 to A31, wherein the pre-defined sequence is constructed from two complementary Golay sequences, each of the complementary Golay sequences being separated by a fixed offset amount, and optionally wherein the values of the pre-defined sequence within the fixed offset amount are zero, and further optionally wherein the time difference (DTG) between the start of the first Golay sequence of the two complementary Golay sequences and the start of the second Golay sequence of the two complementary Golay sequences is user-definable.
Aspect A33. The method of Aspect A32, wherein an output signal is produced by shifting the matched filter result by the DTG to produce a shifted matched filter result, and adding the matched filter result to the shifted matched filter result to produce the output signal.
Aspect A34. The method of Aspect A30, wherein the pre-defined sequence is configured to have a correlation function against N concatenated copies of itself having an autocorrelation peak surrounded by an exclusion zone, wherein the exclusion zone of the correlation function output is zero at all points other than the central autocorrelation peak; and optionally wherein the N concatenated copies of the correlation function are alternatingly multiplied by −1.
Aspect A35. The method of Aspect A30, wherein the output signal is a selected region in the filter output starting at J times the length of the transmitted modulated signal and ending at J+1 times the length of the transmitted modulated signal, and optionally wherein N is a positive integer greater than 1 and J is less than N.
Aspect A36. The method of any preceding Aspect, further including driving a plurality of ultrasound transducers, and wherein each of the plurality of the ultrasound transducers is configured to simultaneously transmit and receive a modulated signal, and optionally wherein the plurality of the ultrasound transducers are operated simultaneously.
Aspect A37. The method of Aspect A36, wherein each of the plurality of ultrasound transducers is configured to transmit a different modulated signal, and wherein each different modulated signal includes a different pre-defined sequence in a family of pre-defined sequences.
Aspect A38. The method of Aspect A37, wherein each different pre-defined sequence in the family of pre-defined sequences has a correlation function against N concatenated copies of itself having an autocorrelation peak and an autocorrelation exclusion zone, wherein each point in the autocorrelation exclusion zone is zero except for the central autocorrelation peak, and wherein each pre-defined sequence in the family of pre-defined sequences has a correlation function against N concatenated copies of each other pre-defined sequence in the family of pre-defined sequences having a cross-correlation exclusion zone in the same region as the autocorrelation exclusion zone, wherein each point in the cross-correlation exclusion zone is zero; and optionally wherein the N concatenated copies of the correlation function are alternatingly multiplied by −1.
Aspect A39. The method of Aspect A38 when dependent on Aspect A34, wherein each pre-defined sequence in the family of pre-defined sequences is a circularly shifted copy of the same pre-defined sequence or is an odd-periodically-circularly shifted copy of the same pre-defined sequence, and optionally wherein the shift is determined by the index of the sequence within the family of the pre-defined sequences and M symbol widths, where M is an integer between 1 and 10000, and wherein the length of the first pre-defined sequence is configured to be the product of the number of transducers and M.
Aspect A40. The method of Aspect A16 when dependent on Aspect A12, wherein each pre-defined sequence in the family of pre-defined sequences is produced using odd-periodic multiplication of a primer sequence against a modified extended Hadamard matrix, wherein the primer sequence is defined as M symbol widths, where M is an integer between 1 and 10000, and wherein a size of the extended Hadamard matrix is configured to produce a family of pre-defined sequences greater than the number of transducers used by the ultrasound device.
Aspect A41. The method of any preceding Aspect, further including measuring a voltage at the terminal using an Analog to Digital Converter, and optionally wherein the A/D converter is configured to have a measurable voltage range larger than the peak voltage output of the electrical driver.
Aspect B1. An ultrasound device including an ultrasound transducer having a terminal for communication with a driver and a receiver, an driver in electrical communication with the ultrasound transducer via the terminal, and an receiver in electrical communication with the ultrasound transducer via the terminal and in electrical communication with the ultrasound driver via the terminal, wherein the ultrasound transducer is configured to simultaneously transmit and receive a modulated signal.
Aspect B2. The ultrasound device of aspect B1, wherein the receiver is configured to continuously measure the received modulated signal.
Aspect B3. The ultrasound device of aspect B1 or aspect B2, wherein the receiver is configured to record the entire modulated signal, and optionally wherein the receiver is configured to record at least twice, or at least ten times, or at least a thousand times the length of the entire modulated signal.
Aspect B4. The ultrasound device of aspect B1 or aspect B2, wherein the receiver is configured to record a portion of the entire modulated signal, and optionally wherein the receiver is configured to record at least 0.1 times, or 0.5 times the length of the entire modulated signal.
Aspect B5. The ultrasound device of any preceding aspect, wherein the modulated signal is modulated according to a pre-defined sequence, and optionally wherein the modulated signal is one of phase, frequency, or amplitude modulated.
Aspect B6. The ultrasound device of any preceding aspect, further including a processor in communication with the receiver and wherein the processor is configured to process the received modulated signal to provide an output indicative of one or more properties of the received modulated signal.
Aspect B7. The ultrasound device of aspect B6, wherein the one or more properties of the received modulated signal include one or more of an amplitude, time of flight, and frequency shift of the received modulated signal relative to the transmitted modulated signal.
Aspect B8. The ultrasound device of aspect B6 or aspect B7, wherein the processor is configured to process the received modulated signal by correlating the received modulated signal with a matched filter including N concatenations of the transmitted modulated signal.
Aspect B9. The ultrasound device of aspect B8, wherein the pre-defined sequence is configured to have a correlation function against itself having an autocorrelation peak and an exclusion zone, wherein in the exclusion zone the autocorrelation of the pre-defined sequence is zero.
Aspect B10. The ultrasound device of aspect B6 or aspect B7, wherein the processor is configured to process the received modulated signal by correlating the received modulated signal with a matched filter including the transmitted modulated signal to produce a correlated result, shifting the correlated result by an offset amount to create a shifted result, and superimposing the correlated result and the shifted result.
Aspect B11. The ultrasound device of aspect B10, wherein the pre-defined sequence is configured to have a correlation function against a corresponding matched filter having an autocorrelation peak and an exclusion zone, wherein in the exclusion zone, the autocorrelation of the pre-defined sequence is zero, and wherein the matched filter is constructed from two complementary Golay sequences separated by the offset amount.
Aspect B12. The ultrasound device of aspect B11, wherein the matched filter is constructed based on at least three concatenations of the pre-defined sequence, such that the matched filter produces an autocorrelation peak and an exclusion zone, wherein in the exclusion zone, the autocorrelation of the pre-defined sequence is zero.
Aspect B13. The ultrasound device of any of aspects B5 to B12, wherein the pre-defined sequence is an aperiodic sequence.
Aspect B14. The ultrasound device of any of aspects B5 to B13, wherein the length of the pre-defined sequence is user-adjustable, such that the signal to noise ratio of the output indicative of the one or more properties of the received modulated signal is configurable.
Aspect B15. The ultrasound device of any preceding aspect, further including a plurality of ultrasound transducers, and wherein each of the plurality of the ultrasound transducers is configured to transmit and receive a modulated signal.
Aspect B16. The ultrasound device of aspect B15, wherein each of the plurality of the ultrasound transducers is configured to transmit a different modulated signal.
AspectB17. The ultrasound device of aspect B16, wherein each different modulated signal is modulated according to a pre-defined sequence in a family of pre-defined sequences, and optionally wherein each pre-defined sequence in the family of pre-defined sequences is a circularly shifted copy of the same pre-defined sequence or is an odd-periodically-circularly shifted copy of the same pre-defined sequence.
AspectB18. The ultrasound device of any preceding aspect, further including an analog to digital (A/D) converter configured to provide a digital output signal corresponding to a voltage measurement at the terminal.
Aspect B19. The ultrasound device of aspect B18, wherein the A/D converter is configured to have a range larger than a voltage range of the ultrasound driver.
Aspect B20. A method of transmitting and receiving ultrasound signals in a medium comprising driving an ultrasound transducer configured to apply a modulated ultrasound signal to the medium, and simultaneously to the driving of the ultrasound transducer, receiving the response of the medium under application of the modulated ultrasound signal.
Aspect B21. The method of aspect B20, wherein the receiving the response of the medium is performed continuously throughout the reception of the entire modulated ultrasound signal.
Aspect B22. The method of aspect B20 or aspect B21, wherein the modulated signal is modulated according to a pre-defined sequence, and optionally wherein the modulated signal is one of phase, frequency or amplitude modulated.
Aspect B23. The method of aspect B22, further including defining the pre-defined sequence by primitive polynomial element generation of prime number Galois Field extensions to at least the power of two, and optionally, wherein the elements of the pre-defined sequence are defined according to the equation:

$$s ( n ) = {[ \frac{{ϵ}^{q n} - {ϵ}^{n}}{{ϵ}^{q} - ϵ} ]}^{\frac{q - 1}{2}} \qquad [ Equation \#2 ]$$

wherein s is the pre-defined sequence, n is the element of the pre-defined sequence, ϵ is the primitive element of the extension field GF(q2), and wherein n exists over the range 0-q.

1. An ultrasound device comprising:
an ultrasound transducer having a terminal;
a driver in electrical communication with the ultrasound transducer via the terminal; and
a receiver in electrical communication with the ultrasound transducer via the terminal, wherein the receiver is in electrical communication with the driver via the terminal, and wherein the ultrasound transducer is configured to simultaneously transmit and receive a modulated signal.

2. The ultrasound device of claim 1, wherein the receiver is configured to continuously measure the terminal of the ultrasound transducer for a duration of the transmitted signal.

3. The ultrasound device of claim 1, wherein the receiver is configured to continuously measure the terminal of the ultrasound transducer for an additional measurement period to make up a received signal.

4. The ultrasound device of claim 1, wherein the transmitted modulated signal is modulated according to a pre-defined sequence and wherein a transmitted modulated property of the transmitted modulated signal comprises one or more of phase, frequency, or amplitude.

5. The ultrasound device of claim 4, where the pre-defined sequence is a binary sequence that takes values of 1 and −1, or a ternary sequence that takes a value of either 0, 1 or −1.

6. The ultrasound device of a claim 1, wherein a modulated component of the transmitted signal is a pre-defined symbol, the pre-defined symbol being matched in frequency content to a frequency response of the ultrasound transducer, such that a pre-defined sequence is used to modulate phase, frequency, or amplitude of repeated copies of the pre-defined symbol.

7. The ultrasound device of claim 1, wherein the transmitted modulated signal is applied to the transducer terminal a first time such that a pre-defined sequence is used aperiodically.

8. The ultrasound device of claim 1, further comprising a processor in communication with the receiver, wherein the processor is configured to filter the received signal using a matched filter constructed from a corresponding template signal to produce an output signal.

9. The ultrasound device of claim 8, wherein the template signal is produced by concatenating N copies of the transmitted modulated signal or wherein the template signal is produced by concatenating N copies of a signal derived from a pre-defined sequence, wherein N is a positive integer greater than 1.

10. (canceled)

11. (canceled)

12. The ultrasound device of claim 9, wherein the pre-defined sequence is configured to have a correlation function against N concatenated copies of itself having a correlation peak surrounded by an exclusion zone, wherein the exclusion zone of a correlation function output is zero at all points other than a central correlation peak.

13. The ultrasound device of claim 9, wherein the output signal is a selected region in the filter output starting at J times a length of the transmitted modulated signal and ending at J+1 times the length of the transmitted modulated signal.

14. The ultrasound device of claim 1, further comprising a plurality of ultrasound transducers, and wherein each of the plurality of the ultrasound transducers is configured to simultaneously transmit and receive a modulated signal or a summation of modulated signals, and optionally wherein each of the plurality of the ultrasound transducers are operated simultaneously.

15. The ultrasound device of claim 14, wherein each of the plurality of ultrasound transducers is configured to transmit a different modulated signal, and wherein each different modulated signal is created from a different pre-defined sequence in a family of pre-defined sequences.

16. The ultrasound device of claim 15, wherein each different pre-defined sequence in the family of pre-defined sequences has a correlation function against N concatenated copies of itself having a correlation peak and an exclusion zone, wherein each point in the exclusion zone is zero except for a central correlation peak, and wherein each pre-defined sequence in the family of pre-defined sequences has a correlation function against N concatenated copies of each other pre-defined sequence in the family of pre-defined sequences having a cross-correlation exclusion zone in a same region as the correlation exclusion zone, wherein each point in the cross-correlation exclusion zone is zero.

17. The ultrasound device of claim 16, wherein each pre-defined sequence in the family of pre-defined sequences is a circularly shifted copy of the same pre-defined sequence or is an odd-periodically-circularly shifted copy of the same pre-defined sequence, and wherein the shift is determined by an index of the sequence within the family of the pre-defined sequences and M elements, where M is an integer larger than 1, and wherein a length of a first pre-defined sequence is configured to be a product of a number of transducers and M.

18. The ultrasound device of claim 16, wherein the ultrasound devices uses a number of transducers, and each pre-defined sequence in the family of pre-defined sequences is produced using odd-periodic multiplication of a primer sequence against a modified extended Hadamard matrix, wherein the primer sequence is defined as M symbol widths, where M is an integer larger than 1, and wherein a size of the extended Hadamard matrix is configured to produce a family of pre-defined sequences greater than the number of transducers used by the ultrasound device.

19. The ultrasound device of claim 14, wherein F pulse-echo output signals are produced by the ultrasound device, wherein F corresponds to a number of transducers used, with the device being configured to filter the received signal from each transducer with its own template signal, where each transducer's own template signal comprises N concatenations of its transmission signal or N concatenations of a signal derived from its pre-defined sequence, and where the pulse-echo output signal is taken to be a region between J and J+1 times a length of the transmission signal from a filter result.

20. The ultrasound device of claim 14, wherein F2-F through transmission signals are produced by filtering a received signal from each transducer with each template signal for each other transducer, and through transmission output signals are taken as a region between J and J+1 times a length of the transmission signal from each filter result, to produce a full matrix of ultrasound data from a single transmission event in which all transducers are operated simultaneously.

21. (canceled)

22. A method of transmitting and receiving Radio Frequency (RF) signals in a medium comprising:
driving an RF transducer configured to apply a modulated RF signal to the medium;
and simultaneously to the driving of the RF transducer, receiving the modulated RF signal and a response of the medium under application of the modulated RF signal.

23. The method of claim 22, wherein receiving the response is performed continuously through a duration of the modulated RF signal from a driver or from the medium, wherein a period of reception is in a range of 1 to 1001 times a length of the transmitted signal.

24-28. (canceled)
